(19) United States
(12) Patent Application Publication
(10) Pub. No.: US 2017/0280643 A1
(43) Pub. Date: Oct. 5, 2017

(54) Method of Improving the Growth and Production Output of Plants of the Family Solanaceae

(71) Applicant: Charles E. Ankner, West Palm Beach, FL (US)

(72) Inventor: Charles E. Ankner, West Palm Beach, FL (US)

(21) Appl. No.: 15/628,689

(22) Filed: Jun. 21, 2017

Related U.S. Application Data
(63) Continuation-in-part of application No. 15/455,805, filed on Mar. 10, 2017.
Application No. 15/455,805 is a division of application No. 14/046,050, filed on Oct. 4, 2013, now Pat. No. 9,622,426.

(51) Int. Cl. A01G 31/02; A01G 1/00

(52) U.S. Cl. CPC A01G 31/02; A01G 1/001; Y02P 60/216

(57) ABSTRACT

A method and system of improving the growth of plants belonging to the family Solanaceae by providing a plant nutrient solution about the plant roots and a gas mixture circulating about the plant shoot; by selecting the gas mixture and plant nutrient solution temperature independently of the other; and providing a plant nutrient solution to gas mixture temperature differential of approximately at least approximately 10° F. during different phases of plant development. The method and system improves plant development to improve a desired plant organ for industrial, scientific, and medical purposes. A method of improving the growth and development of Solanaceae plants by providing a shoot-to-root temperature differential to treat or prevent infection by a plant pathogen and/or infestation by pests.

### CROSS REFERENCE TO RELATED APPLICATION

The present application is a continuation-in-part of U.S. patent application Ser. No. 15/455,805 filed Mar. 10, 2017, entitled METHOD OF IMPROVING THE GROWTH AND PRODUCTION OUTPUT OF PLANTS OF THE FAMILY CANNABACEAE SENSU STRICTO, which is a divisional application of U.S. patent application Ser. No. 14/046,050, filed Oct. 4, 2013, entitled METHOD OF IMPROVING THE GROWTH AND PRODUCTION OUTPUT OF PLANTS OF THE FAMILY CANNABACEAE SENSU STRICTO, published as U.S. Patent Application Publication No. 2015/0096230 A1, now U.S. Pat. No. 9,622,426. The content of both applications are herein incorporated by reference in their entirety.

### FIELD OF THE INVENTION

The present inventive method and system relates to improving the growth and development of Solanaceae plants. More specifically, the invention relates to a method and system of utilizing shoot to root temperature differentials to improve Solanaceae plant growth and development for industrial, scientific, and medical uses. The invention further relates to a method of improving the growth and development of Solanaceae plants by providing a shoot-to-root temperature differential to treat or prevent infection by a plant pathogen and/or infestation by plant pests.

### BACKGROUND OF THE INVENTION

In the beginning God made heaven and earth . . . . Then God said, ‘Behold, I have given you every seed-bearing herb that sows seed on the face of all the earth, and every tree whose fruit yields seed; to you it shall be for food. I also give every green plant as food for all the wild animals of the earth, for all the birds of heaven, and for everything that creeps on the earth in which is the breath of life.’ It was so. Then God saw everything He had made, and indeed, it was very good. So evening and morning were the sixth day. Book of Genesis, Chap 1:1, 29-31, commonly attributed to “the Yahwist”, circa 5^{th} Century B.C.E, as translated and interpreted in The Orthodox Study Bible: Ancient Christianity Speaks to Today's World, Thomas Nelson Publishing, 2008, USA).

The greatest service which can be rendered to any country is to add a useful plant to its culture; especially a bread grain, next in value to bread, is oil., Thomas Jefferson, 3^{rd} President of the United States of America, Memorandum of Services to My Country, 1800, Charlottesville, Va., USA.

It is known in the field of plant husbandry, and in many related fields of endeavor, that a shoot to root temperature differential causes physiological ontogenic changes in plants (i.e. a shoot to root temperature differential during plant development causes physical changes in plant characteristics). Depending upon the plant family, genera, species or variety, purposeful and selected changes in plant characteristics during development caused by providing shoot to root temperature differentials may be exploited for industrial, scientific, and medical uses.

The Solanaceae family includes about ninety genera and approximately three-thousand species, with the largest genus by far being Solanum, having approximately fourteen-hundred species.

Distribution of Solanaceae occurs in tropical and temperate regions throughout the world, with the greatest center of diversity being central and northern South America, and a secondary gathering in Australia.

If one eats, Solanaceae is an indispensable plant family which includes: potatoes, eggplant, tomatoes, tomatillos, and red, green, and yellow peppers—including chili varieties. The world-wide commercial, environmental, and humanitarian importance and value of Solanaceae is difficult to overstate.

Many species of Solanaceae produce tropane alkaloids that have valuable medicinal properties, but which may also be extremely poisonous. Examples include Atropa (belladonna or deadly nightshade), Datura (jimson weed), Mandragora (mandrake), and Hyoscyamus niger (black henbane). Tobacco is also included, with nicotine being an extremely potent and addictive tropane alkaloid. Solanaceae also includes many genera with ornamental species; including Browallia, Physalis, Schizanthus, and Petunia.

Most Solanaceae are erect or climbing, annual or perennial herbs; shrubs are not uncommon but there are very few “true trees”. Leaves vary greatly in shape and are usually simple, although sometimes highly lobed; they alternate and never have stipules. The inflorescence is generally cymose and axillary, but may be reduced to a single flower. The flowers are bisexual, usually radially symmetric, and usually five merous. The calyx is united, at least at the base, and sometimes becomes inflated in fruit. The corolla is also united but its shape varies from long and tubular to rotate or campanulate, usually radially symmetric, but there are some bilaterally symmetric genera. There are five (rarely four-eight) epipetalous stamens that alternate with the corolla lobes. The anthers are sometimes touching but are never fused. The gynoecium consists of a single pistil, usually with two locules and numerous ovules. The fruit is a usually a berry and quite frequently a dry capsule.

The name Solanaceae derives from the genus Solanum, “the nightshade plant”. The etymology of the Latin word is unclear, but the name may come from a perceived resemblance of certain solanaceous flowers to the sun and its rays. One species of genera Solanum is known as the sunberry. Alternatively, the name could originate from the Latin verb solari, meaning to soothe, presumably referring to the soothing pharmacological properties of some of the psychoactive species of the Solanaceae family.

Many of the Solanaceae family, such as tobacco and petunia, are used as model organisms in the investigation of fundamental biological questions at the cellular, molecular, and genetic level.

Solanaceae is modernly grouped into forty-two to forty-four genera, listed by their scientific and/or common names:

Acnlstus Schott—common names include gallinero, hollowheart, wild tobacco, siyou, bastard sirio, galán arbóreo, tabaco de monte, nigilito, marieneira, and tabak djab. Most acnistus are grown as ornamental trees for gardens and natural landscaping to attract various species of birds.

Atropa L.—“bella donna” is Italian for “beautiful lady”, and this common name for atropa originates from its historic use by women for cosmetic purposes. Drops prepared from atropa were used to dilate a young woman's pupils; an effect considered attractive and alluring. Atropa drops act as a muscarinic antagonist, blocking receptors in the muscles of the eye that constrict pupil size. However, prolonged usage was reputed to cause blindness. Modernly, atropa is rarely used this way, carrying the adverse effects of causing minor visual distortions, inability to focus on near objects, and increased heart rate. For medicinal use, atropa has been used in herbal medicine for centuries as a pain reliever, muscle relaxer, anti-inflammatory, for peptic ulcers, histaminic reaction, and motion sickness. At least one 19th-century eclectic medical journal explained how to prepare a atropa tincture for direct administration to patients. Atropa tinctures, decoctions, and powders, as well as alkaloid salt mixtures, are still produced for pharmaceutical use, and these are often standardized with parts hyoscyamine, atropine, scopolamine. The alkaloids are compounded with phenobarbital and/or kaolin and pectin for use in various functional gastrointestinal disorders. The tincture, used for identical purposes, remains in most pharmacopoeias, with a similar tincture of Datura stramonium having been in the U.S. Pharmacopoeia at least until the late 1930s. The combination of atropa and opium, in powder, tincture, or alkaloid form, is particularly useful by mouth or as a suppository for diarrhea and some forms of visceral pain; and can be made by a compounding pharmacist, and may be available as a manufactured fixed combination product in some countries (e.g., B&O Supprettes). A banana-flavored liquid (most common trade name: Donnagel PG) was available until 1992 in the United States. Scopolamine is used as a hydrobromide salt for GI complaints and motion sickness, and to potentiate the analgesic and anxiolytic effects of opioid analgesics. Atropa was formerly used in a painkiller called “twilight sleep” in childbirth. Atropine sulphate is used as a mydriatic and cycloplegic for eye examinations. Atropa is also used as an antidote to organophosphate and carbamate poisoning, and loaded in an auto-injector for use in case of a nerve gas attack. Atropinisation (administration of a sufficient dose to block nerve gas effects) results in one-hundred percent blockade of the muscarinic acetylcholine receptors, and atropine sulphate is the benchmark for measuring the power of anticholinergic drugs. Hyoscyamine is used as the sulphate or hydrobromide for gastrointestinal maladies and also Parkinson's disease. Its side-effect profile is intermediate to those of atropine and scopolamine, and can also be used to combat the toxic effects of organophosphates. Hyoscyamine is the primary alkaloid in Asthmador™, a nonprescription treatment for the relief of bronchial asthma. Scientific evidence to recommend the use of atropa in its natural form for any condition is insufficient, although some of its components, in particular I-atropine, which was purified from atropa in the 1830s, have accepted medical uses. Donnatal® is a prescription pharmaceutical approved in the United States that combines natural atropa alkaloids in a specific fixed ratio with phenobarbital to provide peripheral anticholinergic/antispasmodic action and mild sedation. According to its labeling it is possibly effective for use as adjunctive therapy in the treatment of irritable bowel syndrome (irritable colon, spastic colon, mucous colitis) and acute enterocolitis. For alternative-medicinal use, atropa preparations are used in homeopathy as treatments for various conditions. In clinical use and in research trials, the most common preparation is diluted to the 30 C level in homeopathic notation. This level of dilution does not contain any of the original plant, although preparations with lesser dilutions that statistically contain trace amounts of the plant are advertised for sale. Atropa has been used as recreational drugs because of vivid hallucinations and delirium produced. However, these are most commonly described as very dysphoric and recreational use is considered extremely dangerous due to high risk of unintentional fatal overdose. In addition, the central nervous system effects of atropine include memory disruption and severe confusion. The tropane alkaloids of atropa are used as poisons with early humans producing poisonous arrows from the plant. In Ancient Rome, atropa was used as a poison by Agrippina the Younger, wife of Emperor Claudius, on advice of Locusta, a lady specializing in poisons; and Livia, who is rumored to have used atropa to kill her husband Emperor Augustus. Macbeth of Scotland, when he was still one of the lieutenants of King Duncan I, used atropa during a truce to poison the troops of the invading Harold Harefoot, King of England, to the point that the English troops were unable to stand their ground and had to retreat to their ships. In lore, European “witches” were believed to use a mixture of atropa, opium poppy and other plants, typically poisonous (such as monkshood and poison hemlock), in “flying ointments”, which they applied to themselves to “help fly to gatherings”. Carlo Ginzburg and others have argued that flying ointments were preparations meant to encourage hallucinatory dreaming; a possible explanation for the inclusion of atropa and opium poppy in flying ointments concerns the known antagonism between tropane alkaloids of atropa (to be specific, scopolamine) and opiate alkaloids in the opium poppy, Papaver somniferum (to be specific, morphine), which produces a dream-like waking state. This antagonism was known in folk medicine, discussed in eclectic botanical medicine formularies, and posited as the explanation of how “flying ointments” might have worked in contemporary writing on witchcraft. The antagonism between opiates and tropanes is the original basis of the “twilight sleep” that was provided to Queen Victoria to deaden pain as well as consciousness during childbirth.

Bouchetia Dunal—Bouchetia erecta is a low herbaceous perennial whose few to several stems are slender and grow upright or prostrate up to 20 cm long with sparse hair and inwardly bent trichomes. The leaves are linear to lanceolate-ovate, 1.5 to 3.5 cm long and 0.3 to 1 cm wide. Forwards are narrow at the base wedge-shaped. Both sides are nearly hairless or finely haired. The lower leaves are short-stalked and sessile.

The blooms stand individually with 1.5 to 3 cm long flower stems. The cup is covered with fine hair and occupies 6 to 10 mm long and 2.5 to 4 mm long, unequal or equal, acute or obtuse calyx lobes. The crown is white or blue with fine hairs on the outside. The coronary band has a diameter of about 1 cm, the corolla tube is 1 to 1.5 cm long. The corolla is short and blunt. The five stamens are in two pairs of stamens and a single. The two pairs are either the same length and the single stamen is shorter, or a pair is longer and the remaining three are of equal length. The stamens are 4.5 to 7.5 mm long, the anthers about 1 mm. The counters are divergently on top. The stylus is 6 to 9.5 mm long and is not above the crown out. The fruit is a 5.5 to 7 mm long capsule is enclosed by an enlarging calyx. The seeds are angled, about 1 mm long and reticulate-pitted.

Browallia L.—is named after Johannes Browallius (1707-1755), also known as Johan Browall, a Swedish botanist, physician, and bishop. Browallia is known as Jamaican Forget-Me-Not or Bush-Violet; and, is modernly grown primarily as flowering ornamental plants.

Brugmansia Pers.—is also modernly grown primarily as flowering ornamental plants. In modern medicine however, important alkaloids are found in brugmansia such as scopolamine, hyoscyamine, and atropine; and have proven medical value for their spasmolytic, anti-asthmatic, anticholinergic, narcotic and anesthetic properties. Brugmansia also traditionally been used in many indigenous cultures for medicinal preparations and as entheogens in religious ceremonies. Medicinally, they have primarily been used externally as part of a poultice, tincture, ointment, or where the leaves are directly applied transdermally to the skin. Traditional external uses have included the treating of aches and pains, dermatitis, orchitis, arthritis, rheumatism, headaches, infections, and as an anti-inflammatory. Rarely, brugmansia has been taken internally due to the inherent toxic dangers of ingestion. Internal uses, in highly diluted preparations, and often as a portion of a larger mix, have included treatments for stomach and muscle ailments, as a decongestant, to induce vomiting, to expel worms and parasites, and as a sedative. Several cultures have used brugmansia as a treatment for unruly children in the hopes direct admonishment by their ancestors in the spirit world would make them more compliant. Mixed with maize beer and tobacco leaves, brugmansia was used to sedate wives or slaves before live burial with their departed “loved one”.

Brunfeisia L.—or raintree includes approximately fifty species with the genus named for the German herbalist Otto Brunfels (1488-1534), a pioneer of modern botany. Brunfelsia are neotropical shrubs and small trees with alternately simply arranged leaves usually oval. Large tubular flowers have five broad petals. Typical habitat for wild species is light woodland and thickets. Species in cultivation include Brunfelsia americana and Brunfelsia paucflora. Brunfelsia australis is also actively promoted by cultivators for its tricolored blooms and drought resistance. Brunfelsia are poisonous to domestic animals such as cats, dogs, and horses due to their brunfelsamidine content. Toxicity manifests with strychnine-like gastrointestinal, neurological, and cardiac symptoms.

Calibrachoa Llave & Lex.—are weak evergreen short-lived perennials and subshrubs with a sprawling habit, have small petunia-type flowers, and are found across much the same region of South America inhabiting scrub and open grassland. Calibrachoa are closely related to Petunia; Petchoa is a hybrid genus derived from crossing the genetically similar Calibrachoa and Petunia. Calibrachoa was named by Vicente Cervantes after Antonio de la Cal y Bracho, a 19th-century botanist and pharmacologist. Some Calibrachoa are cultivated as ornamental plants known as “Million Bells”, which can tolerate light frost and thrive in sun or semi-shade.

Capsicum L.—Spanish Colonialists of the 16th and 17^{th} centuries soon became aware of their culinary properties and brought them back to Europe, together with cocoa, potatoes, sweet potatoes, tobacco, maize, and beans. Capsicum were also brought to the Spanish Philippine colonies and then further spread to Asia. Portuguese Colonialists brought capsicum to their African and Asiatic colonies. All capsicum were appreciated; however, the spicy or hot varieties were particularly sought to enliven otherwise monotonous European diets. Spanish cuisine soon benefited from the discovery of chilies in the Americas, and eventually it became very difficult to untangle Spanish style cooking from capsicum chilies. Pepper fruits and peppers can be eaten raw or cooked. Those used in cooking are generally varieties of the C. annuum and C. frutescens species, though a few others are used, as well. Suitable for stuffing with fillings such as cheese, meat, or rice, they are also frequently used both chopped and raw in salads, or cooked in stir-fries or other mixed dishes. They also can be sliced into strips and fried, roasted whole or in pieces, or chopped and added to salsas or other sauces of which they are often a main ingredient. Peppers may be preserved in the form of a jam, or by drying, pickling, or freezing. Dried peppers may be reconstituted whole, or processed into flakes or powders. Pickled or marinated peppers are frequently added to sandwiches or salads. Frozen peppers are used in stews, soups, and salsas. Extracts can be made and added to hot sauces. Modernly, capsicum based agents are also used in mace, tear-gas, and other harassing non-lethal weapons.

Cestrum L.—colloquially known “jessamines”, from “jasmine” due to their fragrant flowers, cestrum are shrubs growing to 1-4 m tall (3 ft 3 in-13 ft 1 in), and native to warm temperate to tropical regions of the Americas from the southernmost United States (Florida, Texas: day-blooming cestrum, C. diurnum) south to the Bio-Bio Region in central Chile (green cestrum, C. parqui). Most are evergreen with a few being deciduous. All parts are toxic causing severe gastroenteritis if ingested. Several species are grown ornamentally for their strongly scented flowers, especially notorious is green cestrum (C. parqui) in Australia, where it can cause serious losses to livestock which eat the leaves, particularly of drying broken branches. C. laevigatum is used “to see far”, i.e. to aid in divination by wajacas (shamans) of the Craós (Krahós, Krahô) tribes of Brazil; being a potent entheogen not to be taken by the uninitiated. Cestrum species are used as food by caterpillars of several lepidoptera species. These include the glasswing (Greta oto), the Antillean clearwing (Greta diaphanus) and Manduca afflicta, which possibly feeds only on day-blooming cestrum. It is suspected that such lepidoptera can sequester the toxins from the plant, making them noxious to many predators. Cestrum species are reported as piscicidal.

Chamaesaracha (A. Gray) Benth.—is a perennial herb commonly known as “five eyes”. With approximately nine species, chamaesaracha are native to the southwestern and western United States and parts of Mexico. They are hairy plants growing low to the ground and covered in crinkly dull green leaves. The flowers are star-shaped to wheel-shaped and their dried remnants can be found around the fruits, which are spherical berries filled with flat, kidney-shaped seeds.

Cyphomandra Mart. ex Sendtn.—or “tree tomato”. Recently, cyphomandra is purported to be a branch within the subgenus Solanum rather than as a separate genus, uniting the members of the old genus with some other Solanum. This lineage is one among a group related to part of the traditional subgenus leptostemonum. Thus, if it is preferred to retain the taxon, cyphomandra is probably best considered a section in Solanum subgenus leptostemonum. Most cyphomandra grow as shrubs or small trees two or three meters in height, with the most well-known species being the widely cultivated tamarillo. Many others are also cultivated as garden plants due to their attractive flowers and fruits. Several other species, e.g. S. cajanumense, S. circinatum, S. sibundoyense, also have fruits that are edible when ripe, and yet others are used as dyestuffs or in folk medicine where they are native.

Datura L.—“Jimsonweed” or “Devil's Trumpet”. All species of Datura are poisonous, especially their seeds and flowers. Due to the potent combination of anticholinergic substances it contains, Datura intoxication typically produces effects like that of an anticholinergic delirium (usually involving a complete inability to differentiate reality from fantasy); hyperthermia; tachycardia; bizarre and possibly violent behavior; and severe mydriasis (dilated pupils) with resultant painful photophobia that can last several days. Pronounced amnesia is another commonly reported effect.

Duboisia R. Br.—commonly called “corkwood tree” is a genus of small perennial shrubs and trees up to fourteen meters tall, with extremely light wood and a thick corky bark. There are four species all occurring in Australia, and one in New Caledonia, having alternate glabrous leaves being narrow and elliptical. The inflorescence is an open cymose panicle ofapically small white flowers, sometimes with a purple or mauve striped tube; flowering profusely in spring. The fruit is a small, globular, black, juicy berry. Aboriginal Australians sometimes chew the nicotine-containing leaves of Duboisia hopwoodii with wood ash to make Pituri, an initial stimulant, but after extended use, a depressant. The leaves of Duboisia leichhardtii and Duboisia myoporoides also contain scopolamine and hyoscyamine, along with some other pharmaceutically important alkaloids. A derivative of scopolamine is the drug butylscopolamine, a potent peripherally acting antispasmodic. Duboisia are commercially grown for pharmaceutical use.

Fabiana Ruiz & Pay.—is native to dry slopes in South America. They are evergreen shrubs with needle-like leaves and profuse tiny tubular flowers in summer. The common name is “false heath” because the leaves superficially resemble those of the distantly related heaths. The species F. imbricata is mainly cultivated as a garden subject. Fabiana is a western South American taxon of resiniferous microphyllous shrubs or chamaephytes. F. imbricate is common horticultural plant and common herbarium specimen, though there have been limited scientific investigations into the species. Members of the genus grow within 16 and 51-degree latitude in the arid mountainous regions of South America, between 1000-4900 m above sea level. While the Solanaceae family has been well studied and documented overall, research attention has not been applied uniformly amongst the genera. Fabiana, with perceived limited commercial or cultural agricultural value have been overlooked in detailed phylogenetic analysis. The proposed number of species included in the genus Fabiana ranges significantly from fifteen to thirty-six. As of 2013 the USDA lists only the single type species within the genus, which indicates lack of commercial interest in the genus, rather than any scientific consensus of species number. Fabiana has been studied by ethnopharmacologists due to the use of extracts from species within the genus in traditional South American medicine. The plants are employed as an antiseptic, anti-inflammatory (through infusions and decoctions), as well as to set broken bones using the resin exuding foliage and branches. European researchers have periodically studied the medicinal value of the plant since as early as 1877. A range of current studies have validated the diuretic, anti-inflammatory, and anti-oxidant for Fabiana species including F. imbricate, F. patagonica, F. punnensis, F. densa, and particularly, F. bryoides, which also inhibited spontaneous mutanogenisis in the bacterium Salmonella typhimumrium by up to 50% with no impact on cell viability. F. imbricate foliage specifically has been traditionally employed as a diueretic and digestive, and has been proven to have a dose-dependent gastroprotective effect, in studies evaluating the main sesquiterpene of the foliage. Interest in F. imbricate has extended into the development of invitro culturing of the plant's tissue for the harvesting of secondary metabolites for further research.

Goetzea Wydler—(also called beautiful goetzea, mata buey, or matabuey) is endemic to Puerto Rico. Today it is limited to the northwestern corner of the island because of deforestation and other consumption of its habitat for human use. Goetzea, federally listed as an endangered species in the United States, is a shrub or a tree which can reach 9 meters in height. The leaves are shiny dark green and oval, bearing yellow-orange funnel-shaped flowers. The fruit is a yellow-orange berry up to 2.5 centimeters long and may be poisonous.

Hunzikeria D'Arcy—commonly texas cupflower (hunzikeria texana) is a perennial subshrub (0-1 ft.) with alternate elliptic, oblanceolate, and spatulate leaves with both acute and obtuse apex, flowering bisexual with four stamens. Blooming in February through May with pink and purple flowers. Distribution is in western edge of the Edwards Plateau of Texas, and probably adjacent Mexico which is predominately limestone soil.

Hyoscyamus L.—henbane with other genera in the same family, is a source of hyoscyamine (daturine). It was historically used in combination with other plants, such as mandrake, deadly nightshade, and datura as an anesthetic potion, as well as for its psychoactive properties in “magic brews”. These psychoactive properties include visual hallucinations and a sensation of flight. It was originally used in continental Europe, Asia, and the Arab world, though it did spread to England in the Middle Ages. The use of henbane by the ancient Greeks was documented by Pliny who said it was “of the nature of wine and therefore offensive to the understanding”, and by Dioscorides who recommended it as a sedative and analgesic. The plant, recorded as Herba Apollinaris, was used to yield oracles by the priestesses of Apollo. Recently evidence for its earlier use in the Scottish Neolithic has been debated. John Gerard's Herball states: “The leaves, the seeds and the juice, when taken internally cause an unquiet sleep, like unto the sleep of drunkenness, which continueth long and is deadly to the patient. To wash the feet in a decoction of Henbane, as also the often smelling of the flowers causeth sleep.” The name henbane dates at least to AD 1265 with the origins being unclear; “hen” probably originally meaning death rather than referring to poultry birds. Hyoscyamine, scopolamine, and other tropane alkaloids have been found in the foliage and seeds of the plant. Common effects of henbane ingestion in humans include hallucinations, dilated pupils, restlessness, and flushed skin. Less common symptoms, such as tachycardia, convulsions, vomiting, hypertension, hyperpyrexia, and ataxia, have all been noted. Henbane can be toxic, even fatal, to animals in low doses. Not all animals are susceptible; for example, the larvae of some lepidoptera species, including cabbage moths, eat henbane. It was sometimes one of the ingredients in gruit, traditionally used in beers as a flavoring. Several cities, most notable Pilsen, were named after its German name form “Bilsenkraut” in context of the production for beer flavoring. It fell out of usage for beer when it was replaced by hops in the 11th to 16th centuries, as the Bavarian Purity Law of 1516 outlawed ingredients other than barley, hops, yeast, and water. Henbane is sometimes identified with the “hebenon” poured into the ear of Hamlet's father, although other candidates for hebenon exist.

Iochroma Benth., nom. cons.—is a genus of about 34 species of shrubs and small trees found in the forests of South America and range from Colombia to Argentina. Their hummingbird-pollinated flowers are tubular or trumpet-shaped, and may be blue, purple, red, yellow, or white, becoming pulpy berries. The cupular calyx is inflated in some species. The leaves are alternate, simple, and entire. Iochromas are cultivated as flowering ornamentals and in cooler zones, and make useful patio shrubs for summer display or conservatory plants. The majority are not frost hardy and must be overwintered under protection. In warmer zones they can be used as landscape plants. They are commonly trained as standards (topiary) to control their size and shape. Iochroma flowers attract hummingbirds and bees to gardens. Like many plants in the Solanaceae family; Iochroma species contain phytochemicals with potential pharmaceutical value but the genus has not been exhaustively studied in this respect. Iochroma fuchsioides is taken by the medicine men of the Kamsa Indians of the Sibundoy valley in the Colombian Andes for difficult diagnoses, with unpleasant side effects lasting several days. A variety of withanolides and hydroxycinnamic acid amides have been isolated from Iochroma species.

Jaborosa Juss.—many species contain steroid-derived compounds called withanolides. Many of the withanolides isolated from Jaborosa have been dubbed jaborosalactones. Some withanolides are phytotoxic, having effects on other plants such as inhibiting germination and radicle growth. Some have antifeedant effects, deterring insects such as mealworms (Tenebrio molitor), the Mediterranean fruit fly (Ceratitis capitata), and the African cotton leafworm (Spodoptera littoralis) from consuming the plant.

Jaltomata Schltdl.—or false holly, has a neotropical distribution, in that species occur from the United States southwest through Latin America, and into the Andean region of South America. Species encompass a wide range of vegetative and reproductive trait variation, including growth habit (trailing herbs, erect herbs, and woody shrubs), floral size, shape and color, as well as fruit size and color. Species may be most notable for their fruits, some of which are eaten by humans in Latin and South America. Depending on the species, fruits may be red, green, orange, or dark purple.

Leucophysalis Rydb.—is a low-growing herbaceous perennial which produces large, white flowers. The species is native to northern zones and only ventures into New England as far south as northwestern Vermont.

Lycianthes (Dunal) Hassler—is primarily cultivated as an ornamental, commonly known as the Blue Potato Bush or Paraguay Nightshade.

Lyclum L.—or desert-thorn, box-thorn, and wolfberry are shrubs, often thorny, growing one-to-four meters tall. The leaves are small, narrow, and fleshy, and are alternately arranged, sometimes in fascicles. Flowers are solitary or borne in clusters. The funnel-shaped or bell-shaped corolla is white, green, or purple in color. The fruit is a two-chambered, usually fleshy and juicy berry which can be red, orange, yellow, or black. It may have few seeds or many. Most Lycium have fleshy, red berries with over ten seeds, but a few American taxa have hard fruits with two seeds. While most Lycium are monoecious, producing bisexual flowers with functional male and female parts, some species are gynodioecious, with some individuals bearing bisexual flowers and some producing functionally female flowers. Lycium has been known to European herbalists since ancient times, and species were traded from the Far East to Europe by the Romans, for example via Ariaca and the port of Barbarikon near today's Karachi, as mentioned in the Periplus of the Erythraean Sea. In his Naturalis Historia, Pliny the Elder describes boxthorn as a medicinal plant recommended as a treatment for sore eyes and inflammation. In his 1753 publication Species Plantarum, Linnaeus describes three Lycium species: L. afrum, L. barbarum, and L. europaeum. L. barbarum. Lycium, particularly L. barbarum, have long been used in traditional Chinese medicine to treat conditions such as male infertility. The leaves and roots of other species of Lycium, more notably L. europaeum, when mixed with water, have been used in folk medicines to treat skin rashes and in promoting hair growth. The fruit of L. barbatum and L. chinense, known as Goji, has become popular in western cultures for its supposed promotion of weight loss and general longevity. The Chinese tonic Fructus Lycii (Gou-Qi-Z:) is made of the fruit of any of several Lycium species, and is used as a supplement, especially for eye health.

Mandragora L.—or mandrake, contain highly biologically active tropane alkaloids. Different parts contain different proportions and concentrations of alkaloids, with the roots having the highest concentration. Alkaloids present include atropine, apoatropine, belladonnine, cuscohygrine, hyoscyamine, scopolamine (hyoscine), 3α-tigloyloxytropane and 3α,6β-ditigloyloxytropane. M. caulescens and M. turcomanica are also reported to contain anisodamine. Clinical reports of the effects of consumption of plants described as Mandragora autumnalis (Mandragora offinarum s.l.) include severe symptoms similar to those of atropine poisoning, including blurred vision, dilation of the pupils (mydriasis), dryness of the mouth, difficulty in urinating, dizziness, headache, vomiting, blushing and a rapid heart rate (tachycardia). Hyperactivity and hallucinations also occurr. Mandragora species have a long use in traditional medicine, extracts being used for their real or supposed aphrodisiac, hypnotic, emetic, purgative, sedative and pain-killing effects. Tropane alkaloids are known to be effective as analgesics and anaesthetics, and can be used to increase circulation and dilate pupils, among other effects. Hyoscine and anisodamine are used medicinally in China.

Margaranthus Schltdl.—or netted globecherry, occurring in the southern parts of Texas, New Mexico, and Arizona south through much of Mexico, with outlying populations in Cuba, Curacao, Costa Rica and Honduras is a peculiar plant that it's the only species in the genus Margaranthus. In detail, they are annual, erect or ascendingly branched herbs 20-60 cm tall, branching sympodially, each leaf appearing to have a branch and flower axillary to it, with narrow band of simple, short curved hairs extending from node to node along underside of each petiole, otherwise glabrous. Leaves, on slender petioles 1-3 cm long, blades elliptic to elliptic-ovate, 8-25 mm wide, 2-5 cm long, broadly cuneate at base, acute at apex, margin entire to sometimes sinuate. Flowers: pedicels 2-4 mm long, slender, coarsely puberulent with white hairs; calyx 2-3 mm long, tubular-subcampanulate at anthesis, puberulent, broadly deltoid teeth 0.4-0.6 mm long, erect; corolla tube longer than calyx, inflated upper part 2-3 mm in diameter, purplish at anthesis, bearing a few scattered minute hairs; fruiting calyx globose-ovoid, 10-12 mm long, finely reticulate-veined, greenish. Fruits: berry 5-6 mm in diameter, glabrous. Ecology: found on shaded slopes or in streamside alluvial soils from 3,500-5,500 ft (1067-1676 m); flowers August-November. Flowers are distinctive with their inflated upper portions constricting to a purplish campanulate.

Nectouxia Kunth—is an erect, perennial herb by means of rhizomes, with glandular hairs. It reaches a size of less than 60 cm in height. The stem is erect, simple or branched from the base. The leaves are arranged alternately to almost opposite, is less than 10 cm long, ovate, pointed, with the base cordate, with soft, petiolate hairs. The pedunculated, hanging, solitary inflorescences in the armpits of the leaves. The chalice of 5 very long narrow sepals, covered with hairs, attached at the base; The yellowish-green corolla (black on drying), is a tube a little longer than the sepals, which reaches the apex dilates and then narrows before dividing into 5 elliptical lobes that curl back, above these lobes project into a small ring. The fruit is a fleshy berry, globose although pointed, of approximately 3 cm in diameter. Numerous seeds, reniform, lenticular, from 2 to 2.5 mm long. Nectouxia have a rather unpleasant smell lending to its folk name—stink-leaf.

Nicandra Adans.—or apple-of-Peru and shoo-fly plant, is thought originally to have been native to Peru (known elsewhere as an introduced species and sometimes as a weed) and is found as a ruderal species in tropical, subtropical and, to a lesser extent, temperate areas world-wide. Long cultivated as an ornamental plant for its attractive flowers and curious fruits (the latter sometimes dried for use in floral design) nicandra has been adopted into the traditional medicine of countries far-removed from its original home.

Nicotiana L.—is indigenous to the Americas, Australia, south west Africa and the South Pacific. Various Nicotiana species, commonly referred to as tobacco plants, are cultivated as ornamental garden plants. N. tabacum is grown worldwide for production of tobacco leaf for cigarettes and other tobacco products. Current classifications include sixty-seven species of nicotiana.

Nierembergia Ruiz & Pay.—or cupflower and purple robe includes twenty or more herbaceous South American perennials and produces hundreds of penny-sized, cup-shaped flowers on top of a low growing mound of narrow foliage. Flowers are blue or white, and species are great as groundcovers, container plants, or for cascading over a wall.

Nothocestrum A. Gray—or aiea; leaves, bark, and tap root are used to make infusions applied topically to treat abscesses, the plant parts being pounded, mixed with water, strained, heated with hot rocks, and cooled before application. The same plant parts were also made into a liquid taken internally to treat abscesses.

Oryctes S. Watson—this rare plant is native to a small area of desert straddling the California—Nevada border, where it grows in habitat with deep sand. It is difficult to estimate its abundance because the plant is only seen in years with certain rainfall amounts and temperature ranges; a small annual herb growing from a taproot and producing sticky, scaly foliage, growing up to about 20 centimeters in maximum height. The leaves are one-to-three centimeters long, linear in shape to oval and divided into lobes, sometimes wavy along the edges. The inflorescences are umbels of a few tiny flowers each, emerging from leaf axils. The flower is purplish and rounded into an urn shape, measuring a few millimeters wide. The fruit is a spherical capsule containing several seeds.

Petunia Juss.—petunias are herbaceous, generally hairy, and the flowers are funnel-shaped, with petals joined together. The fruit is a dry capsule with two compartments and many tiny seeds. Petunias can tolerate relatively harsh conditions and hot climates, need at least five hours of sunlight every day, grow well in low humidity, moist soil. Seedlings are easily grown from seeds. In horticulture, many terms are used to denote different types of cultivated petunias, including Grandiflora, Multiflora, Wave (Spreading), Supertunia, Cascadia, and Surfinia.

Physalis L.—or groundcherry; grow in warm temperate and subtropical regions of the world. Cultivated species and weedy annuals have been introduced worldwide. A notable feature is the formation of a large papery husk derived from the calyx, which partly or fully encloses the fruit. The fruit is small and orange, similar in size, shape and structure to a small tomato. Physalis are herbaceous plants growing to 0.4 to 3 m tall, similar to the common tomato, a plant of the same family, but usually with a stiffer, more upright stem. They can be either annual or perennial. Most require full sun and warm to hot temperatures. Some species are sensitive to frost, but others, such as the Chinese lantern, P. alkekengi, tolerate severe cold when dormant in winter. These plants grow in most soil types and do very well in poor soils and in pots, and require moisture until fruiting. Plants are susceptible to many of the common tomato diseases and pests, and other pests such as aphids, whiteflies, spider mites, and the false potato beetle (Leptinotarsa juncta) also attack them. Propagation is by seed. Some species are self-incompatible and require pollen from other plants to bear fruit. Not all Physalis species bear edible fruit. Select species are cultivated for their edible fruit, however; the typical Physalis fruit is like a firm tomato in texture, and like strawberries or pineapple in flavor, with a mild acidity. Some species, such as the Cape gooseberry and tomatillo have been bred into many cultivars with varying flavors, from tart to sweet to savory. Physalis fruit are rich in cryptoxanthin. Once extracted from its husk, the fruit can be eaten raw and used in salads. Some varieties are added to desserts, used as flavoring, made into fruit preserves, or dried and used like raisins. They contain pectin and can be used in pie filling. The Cape gooseberry is native to the Americas, but is common in many subtropical areas. Its use in South Africa near the Cape of Good Hope inspired its common name. Other species of commercial importance include the tomatillo (P. philadelphica). Some nations, such as Colombia, have a significant economic trade in Physalis fruit. Some species are grown as ornamental plants. For example, the hardy Physalis alkekengi has edible small fruits but is most popular for its large, bright orange to red husks. In Chinese medicine, Physalis species are used as to treat such conditions as abscesses, coughs, fevers, and sore throat. Smooth groundcherry (P. subglabrata) is classified as a hallucinogenic plant, and its cultivation for other than ornamental purposes is outlawed in the US state of Louisiana under State Act 159.

Quincula Raf.—is native to the southwestern United States as far east as Kansas and Oklahoma, as well as northern Mexico, where it grows in many types of open, dry habitat, including disturbed areas. It is a perennial herb producing ridged, spreading stems up to half a meter long. The lance-shaped leaves are up to 7 centimeters long, smooth or lobed on the edges. The flowers blooming from the leaf axils are up to 2 centimeters wide, widely bell-shaped or flat-faced with five vague, pointed lobes, not drooping like those of many Physalis species. They are purple in color, sometimes with white deep in the throats. The bell-shaped calyx of sepals at the base of the flower enlarges as the fruit develops, becoming an inflated, lanternlike structure up to 2 centimeters long which contains the berry.

Salpichroa Miers—S. origanifolia is known by the common names lily of the valley vine, pampas lily-of-the-valley or cock's-eggs. It is native to South America and is naturalized in Africa, Australasia, Europe, and North America. It is commonly grown as an ornamental plant. In Tasmania, it is regarded as a toxic weed and its sale and distribution are illegal.

Salpiglossis K. Koch—S. sinuata is an annual or short-lived perennial herbaceous plant growing to 60 cm (2.0 ft) tall, rarely up to 1 m (3.3 ft) tall. The leaves are 4-10 cm (1.6-3.9 in) long, elliptic to lanceolate, with a wavy, lobed or toothed margin. The flowers have a five-lobed funnel-shaped corolla, up to 7 cm (2.8 in) long and 5.5 cm (2.2 in) diameter, each lobe with a notched apex, velvety in texture, either violet or orange, and have contrasting darker stripes along each petal. Of the two species in its genus, S. sinuata is the more commonly grown as an ornamental plant for gardens. It was introduced to the northern hemisphere in the 1820s. Many cultivars have been selected for different flower colors.

Schizanthus Ruiz & Pav.—annual or biennial, glandulous-pubescent herbaceous plants, with alternate, pinnatilobate or bipinnatisect leaves and attractive flowers, arranged at the end of stems. The flowers are zygomorphic and hermaphrodite. The calyx has 5 parts, with linear or spatulate segments. The corolla is bilabiate; the superior labia is tripartite, with the central lobe complete and notched and the two laterals bifid. The inferior labia is tripartite with the central lobe notched, almond-shaped and the laterals are complete. The androecium is formed of 4(5) didynamous stamens, the two or three inferior stamens are reduced to staminodes. The fruit is a pluriseminate boll, dehiscent by two bifid valves. The basic chromosome number is x=10. Plants in the Schizanthus genus are basically entomophilous, that is, they require that their pollen is transported from plant to plant by insects. The majority of Schizanthus species are pollinated by hymenoptera (bees, bumblebees and wasps of the genera Alloscirtetica, Bombus, and Megachile, among others). However, the species with white flowers (S. candidus, S. integrifolius and S. lacteus) are pollinated by moths. Finally, Schizanthus grahamii is pollinated by hummingbirds (such as, for example, Oreotrochilus leucopleurus). In addition to its notable bilateral symmetry, the flower's coloring and other characteristics that these species use to attract insects, this genus has a particular adaptation to ensure that visiting insects become covered in pollen. While the great majority of solanaceas exhibit poricidal pollen dehiscence, this species uses an explosive mechanism for the liberation of its pollen, which is released by the anthers when an insect lands on a flower, ensuring that the insect is covered in pollen and that it will carry it to other flowers. This mechanism favors cross pollination (allogamy or xenogamy) in these plants. Alkaloids are nitrogenous organic substances that are produced by plants as a secondary metabolite and which have an intense physiological action on animals even at low doses. The tropanes are the most well-known of the alkaloids that are found in the solanaceas. The plants that contain these substances have been used by man for centauries as poisons. However, despite being recognized as a poison many of these substances have invaluable pharmaceutical properties. Schizanthus contain a great diversity of alkaloids. Various types of tropanes have been isolated from different species of the genus. Derivatives of hydroxytropane and angeloyloxytropane have been detected in Schizanthus alpestris, Schizanthus grahamii, Schizanthus. hookerii, Schizanthus litoralis and Schizanthus pinnatus. Schizantines. esters of hydroxytropane have been detected in Schizanthus grahamii and derivatives of mesaconic acid and itaconic acid have been found in Schizanthus litoralis.

Scopolia Jacq.—scopolia is a genus of five species native to Europe and Asia named after naturalist Giovanni Scopoli (1723-88). Scopolia carniolica is a creeping perennial with light green leaves and pale yellow to dull red flowers. It is sometimes cultivated as a decorative plant. Scopolia's extract (which contains a form of the alkaloid scopolamine) is used in at least one commercial stomach remedy Inosea, produced by Sato Pharmaceutical. The extract is an anti-spasmodic in low doses and may be used to relax smooth muscle tissue or prevent motion-sickness induced nausea; in higher doses it is a poisonous narcotic having hallucinogenic and memory-inhibiting effects. Other alkaloids found in Scopolia carniolica include cuscohygrine and hyoscyamine. Alkaloids found in Scopolia tangutica include hyoscyamine, scopolamine, anisodamine, and anisodine. Alkaloids found in Scopolia atropoides (possibly just a synonym for Scopolia carniolica) include atroscine. The coumarin phenylpropanoids umbelliferone and scopoletin have been isolated from the roots of Scopolia japonica. The related species Atropanthe sinensis is sometimes included in Scopolia as Scopolia sinensis.

Solandra Sw.—solandra vines are commonly known as chalice vines and are native to the Caribbean, Mexico and South America. They have very large flowers and glossy foliage which was and is used by the Huichol of Mexico and other tribes of the region where it is known by the name “kieli” or “kieri” with some archaeological evidence supporting the theory that its use predates that of peyote (Lophophora williamsii).

Solanum L.—nightshade. Solanum species show a wide range of growing habits, such as annual and perennials, vines, subshrubs, shrubs, and small trees. Many formerly independent genera like Lycopersicon (the tomatoes) and Cyphomandra are now included in Solanum as subgenera or sections. Thus, the genus today contains roughly 1,500-2,000 species. The generic name was first used by Pliny the Elder (23-79) for a plant also known as strychnos, most likely S. nigrum. The species most commonly called nightshade in North America and Britain is Solanum dulcamara, also called bittersweet or woody nightshade. Its foliage and egg-shaped red berries are poisonous, the active principle being solanine, which can cause convulsions and death if taken in large doses. The black nightshade (S. nigrum) is also generally considered poisonous, but its fully ripened fruit and foliage are cooked and eaten in some areas. The deadly nightshade (Atropa belladonna) is not in the Solanum genus, but is a member of the wider Solanaceae family. Most parts of the plants, especially the green parts and unripe fruit, are poisonous to humans (although not necessarily to other animals), but many species in the genus bear some edible parts, such as fruits, leaves, or tubers. Three crops have been bred and harvested for consumption by humans for centuries, and are now cultivated on a global scale, including but not limited to:

S. lycopersicum, or tomato, varieties are sometimes bred from both S. lycopersicum and wild tomato species such as S. pimpinellifolium, S. peruvianum, S. cheesmanii, S. galapagense, S. chilense, etc. Such varieties include-among others-Bicentennial, Dwarf Italian, Epoch, Golden Sphere, Hawaii, Ida Red, Indigo Rose, Kauai, Lanai, Marion, Maui, Molokai, Niihau, Oahu, Owyhee, Parma, Payette, Red Lode, Super Star, Surecrop, Tuckers Forcing, V 121, Vantage, Vetomold, and Waltham.

S. tuberosum, potato, has been bred into many standard or well-known varieties, each of which has particular agricultural or culinary attributes, out of over 4,000 varieties. In general, varieties are categorized into a few main groups, such as russets, reds, whites, yellows (also called Yukons) and purples-based on common characteristics. Around 80 varieties are commercially available in the UK. For culinary purposes, varieties are often differentiated by their waxiness. Floury, or mealy (baking) potatoes have more starch (20-22%) than waxy (boiling) potatoes (16-18%). The distinction may also arise from variation in the comparative ratio of two potato starch compounds: amylose and amylopectin. Amylose, a long-chain molecule, diffuses from the starch granule when cooked in water, and lends itself to dishes where the potato is mashed. Varieties that contain a slightly higher amylopectin content, a highly branched molecule, help the potato retain its shape when boiled. Popular S. tuberosum varieties cultivated worldwide include: Adirondack Blue, Adirondack Red, Agata, Almond, Alpine Russet, Alturas, Amandine, Annabelle, Anya, Arran Victory, Atlantic, Austrian Crescent, Avalanche, Bamberg, Bannock Russet, Belle de Fontenay, BF-15, Bildtstar, Bintje, Blazer Russet, Blue Congo, Bonnotte, British Queen, Cabritas, Camota, Canela Russet, Cara, Carola, Chelina, Chiloé, Cielo, Clavela Blanca, D\tilde{e}sir\tilde{e}e, Estima, Fianna, Fingerling, Flava, French Fingerling, German Butterball, Golden Wonder, Goldrush, Home Guard, Innovator, Irish Cobbler, Irish Lumper, Jersey Royal, Kennebec, Kerr's Pink, Kestrel, Keuka Gold, King Edward, Kipfler, Lady Balfour, Langlade, Linda, Marcy, Marfona, Maris Piper, Marquis, Megachip, Melody, Monalisa, Nicola, Norgold Russet, Pachacofta, Pike, Pink Eye, Pink Fir Apple, Primura, Ranger Russet, Ratte, Record, Red La Soda, Red Norland, Red Pontiac, Rooster, Russet Burbank, Russet Norkotah, Selma, Shepody, Sieglinde, Silverton Russet, Sirco, Snowden, Spunta, Up to date, Stobrawa, Superior, Umatilla Russet, Villetta Rose, Vivaldi, Vitelotte, Yellow Finn, and Yukon Gold.

S. melongena eggplant (aubergine), cultivars of eggplant produce fruit of different size, shape, and color, though typically purple. The most widely cultivated varieties in Europe and North America today are elongated ovoid, 12-25 cm long (4½ to 9 in) and 6-9 cm broad (2 to 4 in) with a dark purple skin. A much wider range of shapes, sizes, and colors is grown in India and elsewhere in Asia. Larger cultivars weighing up to a kilogram (2.2 pounds) grow in the region between the Ganges and Yamuna Rivers, while smaller ones are found elsewhere. Colors vary from white to yellow or green, as well as reddish-purple and dark purple. Some cultivars have a color gradient—white at the stem, to bright pink, deep purple or even black. Green or purple cultivars with white striping also exist. Chinese cultivars are commonly shaped like a narrower, slightly pendulous cucumber. Oval or elongated oval-shaped and black-skinned cultivars include Harris Special Hibush, Burpee Hybrid, Bringal Bloom, Black Magic, Classic, Dusky, and Black Beauty. Slim cultivars in purple-black skin include Little Fingers, Ichiban, Pingtung Long, and Tycoon. In green skin, Louisiana Long Green and Thai (Long) Green. In white skin, Dourga. Traditional, white-skinned, egg-shaped cultivars include Casper and Easter Egg. Bicolored cultivars with color gradient include Rosa Bianca, Violetta di Firenze, Bianca Sfumata di Rosa (heirloom), and Prosperosa (heirloom). Bicolored cultivars with striping include Listada de Gandia and Udumalapet. In some parts of India, miniature cultivars, most commonly called vengan, are popular. Varieties S. m. var. esculentum—common aubergine, including white varieties, with many cultivars. S. m. var. depressum—dwarf aubergine, and S. m. var. serpentium—snake aubergine. Other varieties are significant food crops regionally, such as Ethiopian eggplant and gilo (S. aethiopicum), naranjilla or lulo (S. quitoense), turkey berry (S. torvum), pepino (S. muricatum), Tamarillo, or bush tomatoes. The species most widely seen in cultivation as ornamental plants are: S. aviculare (kangaroo apple), S. capsicastrum (false Jerusalem cherry, winter cherry), S. crispum (Chilean potato tree), S. laciniatum (kangaroo apple), S. laxum (potato vine), S. pseudocapsicum (Christmas cherry, winter cherry), S. rantonnelii (blue potato bush), S. seaforthianum (Italian jasmine, St. Vincent lilac), S. wendlandii (paradise flower, potato vine).

Streptosolen Miers—is a genus of flowering plants with a single species, Streptosolen jamesonii, the marmalade bush. It is an evergreen shrub that produces loose clusters of flowers gradually changing from yellow to red as they develop, resulting in an overall appearance resembling orange marmalade (thus the name), found in open woodlands of Colombia, Ecuador, and Peru. The stems tend to be tall and slender, with an overall height of 1-2 meters (3.3-6.6 ft). The leaves are ovate to elliptic, green to dark green, with a pattern of fine wrinkles. The flowers have a slender tube 3-4 cm long, with spreading petal lobes. The blooms can appear nearly all year in mild-winter areas, but the heaviest flowering is from spring through fall. With a minimum temperature of 7° C. (45° F.), this plant must be overwintered indoors in frost-prone areas.

Withania Pauquy—is a flowering plant native to parts of North Africa, western Asia, south Asia, southern Europe, the Mediterranean, and the Canary Islands. Two of the species, W. somnifera (Ashwagandha) and W. coagulans (Ashutosh booti), are economically significant, and are cultivated in several regions for their medicinal uses.

In known horticultural and agricultural systems, the temperature of the growing medium, such as soil, soil replacements, liquids, air-misting, aquaponic reservoirs, and the like, maintain the plant root system temperature within a few degrees of the air/gas mixture about the plant shoot. In other words, in known systems, “the roots are typically as hot as the shoot”.

However, by maintaining a plant shoot to root temperature differential by lowering the root temperature, the dissolved oxygen saturation level of the nutrient solution within the growth medium may be increased which in turn increases the oxygen and nutrient uptake of the plant. In basic terms; the lower the growth medium nutrient solution temperature, the more oxygen may be dissolved within the solution. This increased dissolved oxygen increases the permeability of the plant roots to water and minerals, which increases plant nutrient uptake, thus increasing the growth rate and overall health of the plant.

As may be deduced, there is interplay between plant solution oxygen solubility and plant nutrient uptake. As oxygen solubility increases, so does plant nutrient uptake. Ordinarily, this increase would be viewed as advantageous. However, in most hydroponic or aquaponic growing systems, as well as in irrigated outdoor farming, nutrient solutions and/or fertilizers have preferred and specific nitrogen-phosphorous-potassium (hereinafter “N-P-K”) concentrations tailored to specific varieties of plants, and further tailored to the growth phases of those plant varieties and varietal strains. Many of these N-P-K formulations are high in concentration and intended to maximize crop yield; and yet be at levels just below a point which begins to damage or “chemically burn” the plant. As selected plant nutrient solution temperatures are lowered, the increased nutrient uptake of the plant requires differing solution N-P-K concentration levels and ratios to improve overall plant development without damaging or “chemically burning” the plant.

Another known public domain aspect of Solanaceae plant cultivation is gas mixture carbon-dioxide augmentation. Introducing supplemental carbon-dioxide into ambient air about a plant shoot is known to increase crop yield up to approximately 30%. This increase is caused by improved plant transpiration and thus improved photosynthesis and carbohydrate transfer. A further aspect of this known method is that due to improved plant transpiration, the plant can withstand higher shoot temperatures, and correspondingly higher levels of luminance intensity. Higher levels of luminance intensity results in improved photosynthesis, and typically an additional 20-30% improvement in crop yield.

As is also well known in agriculture and horticulture, in many plant varieties, high nutrient solution temperatures can cause root system oxygen starvation. As the temperature increases, nutrient solution oxygen solubility dramatically decreases and the plant essentially suffocates. Plant injury from hypoxia (low, or no oxygen) at the roots may take several forms, each differing in severity and depending upon the plant family and variety.

Typically, the first sign of root suffocation is wilting of the plant shoot during the warmest part of the day when temperatures and light levels are highest, or the overall wilting of plants grown with artificial illumination in controlled conditions. Insufficient oxygen reduces the permeability of roots to water and results in the accumulation of toxins, thus both water and minerals cannot be absorbed in sufficient quantities to support plant growth, particularly under plant stress conditions.

This wilting is accompanied by slower rates of photosynthesis and carbohydrate transfer, and over time plant growth is reduced and crop yields are negatively affected. If oxygen starvation continues, mineral deficiencies in the plant will set-in, roots will die back, and plants will become stunted. Under these continuing anaerobic conditions, plants produce a stress hormone, ethylene, which accumulates in the roots and causes the collapse of root cells. Once root injury and deterioration caused by anaerobic conditions has begun, common opportunist pathogens such as Pythium Fusarium, Verticillium, and Rizoctonia, and the like, can easily infect and rapidly destroy the plant. To compound this root vulnerability, higher temperature water and/or nutrient solution provide a fertile habitat for many plant pathogens and pests.

In such tragic cases, even highly trained and experienced horticulturalist mistakenly treat this “root rot” by attempting to prevent or destroy the pathogens by using various techniques and/or chemicals, rather than by lowering the temperature of the nutrient solution during growth and thus promoting a strong and vigorous root system which naturally protects against such common pathogens.

Known and undesirable methods attempting to prevent and/or treat this “root rot” include; filtering the nutrient solution by reverse-osmosis, “sterilizing” the nutrient solution with hydrogen-peroxide, ozone, or other chemicals, irradiating the nutrient solution with high intensity ultraviolet light, or by other means; and also by introducing a so called “beneficial” pathogen to prevent or destroy an “unwanted” pathogen.

Additionally, opportunistic plant pathogens and pests above the root crown can and do quickly infect, infest, and destroy plants. Such known pathogens and pests include insects, fungi, molds, mildews, bacterium, and combinations thereof.

U.S. Pat. Appln. No. 2012/0210640 by Ivanovic discloses a hydroponic growth system wherein nutrient solution temperature is an environmental parameter monitored and controlled by automatic means.

U.S. Pat. Appln. No. 2009/0223128 by Kuschak discloses a hydroponic growth system wherein nutrient solution temperature is an environmental parameter monitored and controlled by automatic and remote means.

U.S. Pat. No. 8,443,546 to Darin discloses a hydroponic growth system wherein a small self-contained water chiller is optionally provided for reducing high nutrient solution reservoir temperatures caused by close proximity to high heat illumination sources.

U.S. Pat. No. 6,216,390 to Peregrin Gonzalez discloses a hydroponic system wherein the nutrient solution temperature is utilized to maintain the air temperature about the plants being grown.

U.S. Pat. No. 5,813,168 to Clendening discloses a greenhouse hydroponic system wherein the nutrient solution temperature is held at approximately 55° F., and utilized to maintain the air temperature about the plants being grown.

U.S. Pat. No. 5,771,634 to Fudger discloses a small home-style computer controlled hydroponic system which automatically maintains various growing parameters such as air temperature, air humidity, illumination cycles, and nutrient solution recirculation.

U.S. Pat. No. 5,501,037 to Aldokimov, et al. discloses an industrial hydroponic system wherein the frequency and duration of nutrient solution release is modified and controlled in accordance with the ambient air temperature.

Taiwan Pat. Appln. No. TW 20080106998 by Chen discloses a hydroponic method which holds plant nutrient solution temperature at 64° F. during winter and 72° F. during summer so plants survive ambient air temperature extremes and reduce the cost of maintaining the ambient air temperature about plant shoots to between 41° F. and 95° F., while preventing plant damage at ambient air temperatures above and below that range.

Chinese Pat. No. CN1253715A to Zhaozhang discloses a method of planting young fruit trees out of season by providing heating pipes about the tree root system, trunk, and branches.

Chinese Pat. Appl. No. CN101653089A by Wu discloses a method of protecting crops from low ambient air temperatures by providing irrigation pipes about the plant root system and supplying warm irrigation solution to keep both the root system and by evaporation the plant shoot system warm.

None of these known prior art systems, however, disclose or teach a method of providing a temperature differential between the shoot and root systems of a plant; nor do they state, suggest, imply, or infer a motivation to do so. Moreover, all of these known prior-art systems teach away from providing a temperature differential between the plant shoot and root systems; indicative of the common and yet errant notion that plant shoot temperature and plant root temperature should be approximately the same throughout all growth phases of plant development.

Dutch Pat. Appln. No. NL1020694 to/by Korsten (hereinafter “Korsten”) discloses making use of the principle of an inverted or reverse temperature gradient for saving energy heating a greenhouse environment. By placing the plants as close together as possible, combined with the use of insulating materials placed around the plant containers, a 20-30% energy saving is purported by creating a “micro-climate” about each plant (disclosed as a 1 meter space or sphere about the plant).

Korsten also discloses a 7° C. temperature gradient between the greenhouse environment and the growing medium about the plant roots. However, Korsten fails to disclose a distance from the plants from which this gradient extends. Therefore, the 7° C. temperature gradient value disclosed is meaningless. However, if the distance from the plant is presumed to be the disclosed “micro-climate” of 1 meter, then it can be inferred that Korsten discloses a temperature gradient of no greater than 7° C. for every 1 meter distance from the plant root system.

A stated objective of Korsten is to save energy in heating a greenhouse by grouping plants together, providing heat to the growing medium about the roots, and creating a “micro-climate” about the plants, and that this “micro-climate” will aid a grower in providing more controllable cultivation during plant flowering or fruiting morphology.

However, Korsten fails to disclose or teach a method of providing a temperature differential between the shoot and root systems of the plant for the purpose of changing plant physiological ontogeny or morphogeny; nor does Korsten state, suggest, imply or infer a motivation to do so. Korsten also does not disclose a plant family or genus, which renders the disclosure moot as to preferred and specific environmental growing conditions.

It is desired to provide a method and system to overcome the above-mentioned disadvantages in the prior art.

### SUMMARY OF THE INVENTION

What is desired is a method of improving the growth of plants of the family Cannabaceae s.s by maintaining a plant shoot temperature which differs from the plant root system temperature based at least in part upon the plant variety, the growth phase of the plant, and the plant organ for desired improvement, by providing a gas mixture temperature about the plant shoot which differs from the growth medium and/or plant growth nutrient solution temperature about the plant root system, whereby the plant shoot temperature may be maintained independently of the plant root system temperature.

What is desired is a method of improving the growth of plants of the family Solanaceae by providing a plant nutrient solution temperature and/or gas mixture temperature intolerant to plant pathogens and pests, and a temperature which does not cause irremediable damage to the plant variety being improved

It is an object of the present invention to provide a method of improving the growth of plants belonging to the family Solanaceae comprising: providing a plant growing system configured for growing a Solanaceae plant having roots and a shoot, the plant growing system including a plant nutrient solution about the plant roots and a gas mixture circulating about the plant shoot; selecting the gas mixture temperature; selecting the plant nutrient solution temperature independently of the gas mixture temperature; and providing a plant nutrient solution to gas mixture temperature differential of approximately at least 10° F. during different phases of plant development.

It is an object of the present invention to provide a method of preventing or treating infection by a pathogen of, or infestation by a pest, of plants belonging to the family Solanaceae comprising: providing a plant growing system configured for growing a Solanaceae plant having roots and a shoot, the plant growing system including a plant nutrient solution about the plant roots and a gas mixture circulating about the plant shoot; selecting either a gas mixture temperature or a nutrient solution temperature independently of the other; whereby the selected temperature is intolerant to a pathogen or pest belonging to the group consisting of insects, fungi, molds, mildews, bacterium, and combinations thereof.

It is an object of the present invention to provide a plant growing system configured to grow a Solanaceae plant having roots and a shoot, the plant growing system comprising: a plant nutrient solution located about the roots of the plant; and a gas mixture circulating about the shoot of the plant, wherein the gas mixture has a temperature that is selected independently of or based at least in part on a temperature of the plant nutrient solution, and wherein during different phases of plant development, a plant nutrient solution to gas mixture temperature differential is provided such that the temperature differential is greater than approximately 10° F. during at least part of one of the different phases of plant development.

It is an object of the present invention to provide a method to improve the growth of Solanaceae plants wherein a gas mixture carbon-dioxide level is increased based at least in part upon the selected plant nutrient temperature to gas mixture temperature differential.

It is an object of the present invention is to provide a method to improve the growth of Solanaceae plants wherein any change to a selected gas mixture temperature or a selected plant nutrient solution temperature is made in less than approximately 20° F. increments during any one twenty-four-hour period.

### BRIEF DESCRIPTION OF THE DRAWINGS

FIG. 1 is a schematic diagram of one embodiment of the inventive method.

FIG. 2 is a schematic diagram of another embodiment of the inventive method.

FIG. 3 is a schematic diagram of yet another embodiment of the inventive method.

FIG. 4 is a schematic diagram of a Solanaceae plant's development indicating various stages of shoot to root temperature differential provided to improve selected plant organs.

FIG. 5 is a schematic diagram of a Solanaceae plant's development indicating various stages of shoot to root temperature differential provided to improve selected plant organs.

FIG. 6 is a schematic diagram of a Solanaceae plant's development indicative of a period of low root temperature provided to prevent or treat infection by a plant pathogen or pest.

FIG. 7 is a schematic diagram of a Solanaceae plant's development indicative of periods of low root temperature provided to prevent or treat infection by a plant pathogen or pest.

FIG. 8 is a schematic diagram of a Solanaceae plant's development indicative of a period of low shoot temperature provided to prevent or treat infection by a plant pathogen or pest.

FIG. 9 is a schematic diagram of a Solanaceae plant's development indicative of periods of low shoot temperature provided to prevent or treat infection by a plant pathogen or pest.

### DETAILED DESCRIPTION OF THE INVENTION

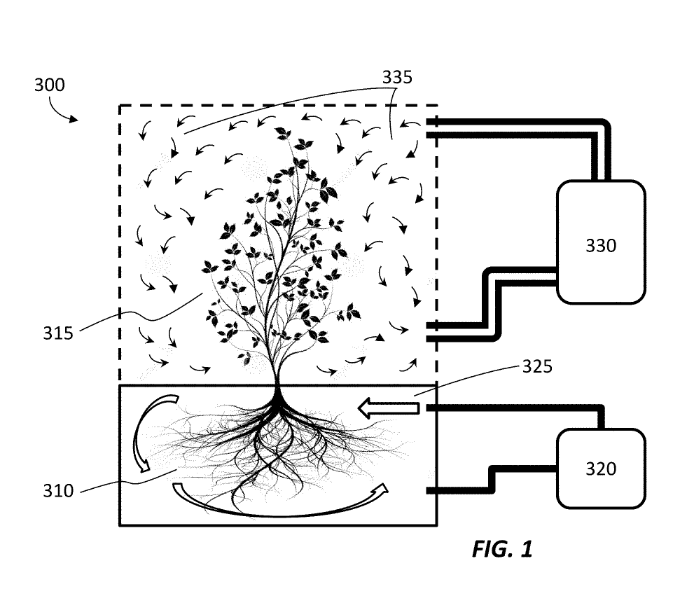

As depicted in FIG. 1, the inventive method provides a plant growing system (300) configured for growing a Solanaceae plant having roots (310) and a shoot (315). The plant growing system includes a plant nutrient solution (320) about (325) the plant roots (310) and a gas mixture (330) circulating about (335) the plant shoot (315). It is contemplated that the plant growing system (300) is insulated, air-tight, and water-tight to the extent required as to maintain a desired temperature differential between the plant root (310) and plant shoot (315). Many and varied plant growing system types and techniques may be provided; such as hydroponic drip, ebb and flow, nutrient film technique, deep water culture, wick systems, aquaponic system, and the like, and to include known configurations which may be easily adapted to independently select and maintain both plant root (310) and plant shoot (315) temperatures.

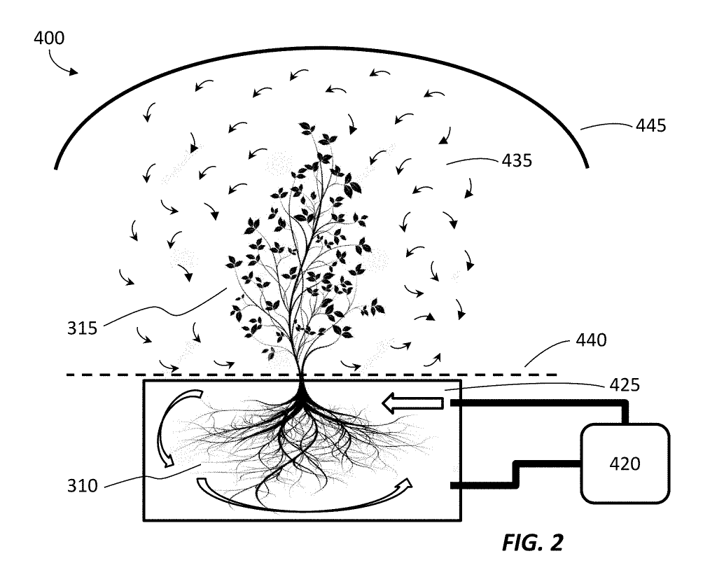

As depicted in FIG. 2, the inventive method provides a plant growing system (400) adapted for outdoor hydroponic or aquaponic cultivation of a Solanaceae plant having roots (310) and a shoot (315). The plant growing system (400) includes a plant nutrient solution (420) about (425) the plant roots (310) and allows for air to circulate about (435) the plant shoot (315). It is contemplated that the plant growing system is insulated and water-tight to the extent required as to maintain a desired temperature differential between the plant root (310) and plant shoot (315). Additionally, insulative light reflecting or absorbing material (440) may be placed between the plant shoot and root to facilitate and maintain a desired temperature differential. Still further, insulative or dissipative light reflecting or absorbing material (445) may be suspended over the plant shoot (315) to facilitate and maintain a desired temperature differential. Many and varied plant growing system (400) types and techniques may be provided; such as hydroponic drip, ebb and flow, nutrient film technique, deep water culture, wick systems, aquaponic system, and the like, and to include known configurations which may be easily adapted to select and maintain a plant root (310) temperature independently of the circulating air (435) temperature and/or plant shoot (315) temperature.

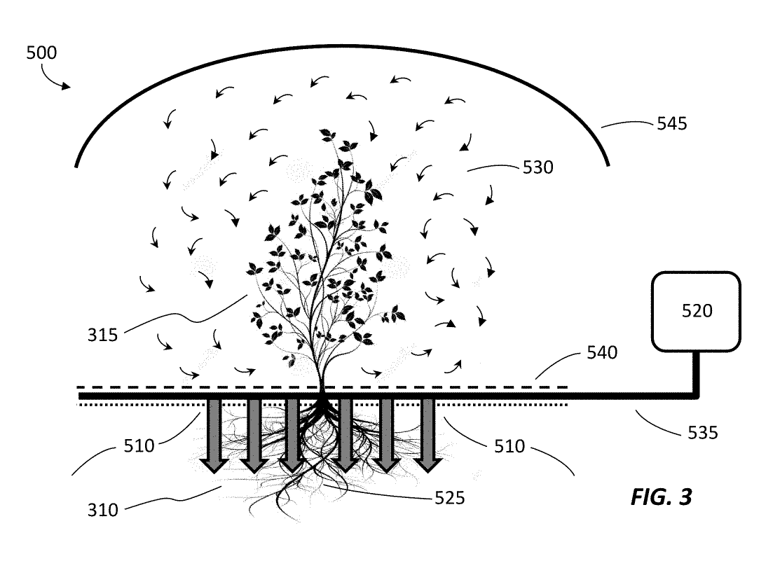

As depicted in FIG. 3, the inventive method provides a plant growing system (500) adapted to outdoor soil (510) based irrigation farming of a Solanaceae plant having roots (310) and a shoot (315). The plant growing system (500) includes an irrigation plant nutrient solution (520) which is conveyed to the plant roots (525) via conventional irrigation means other than “through the air broadcast” or “sprinkler type” techniques. Preferably, drip or troth type irrigation techniques are used as to not alter the shoot (315) temperature of the plant when a temperature differential is desired. Based at least in part on the temperature of the air allowed to circulate about (530) the plant shoot (315), the irrigation plant nutrient solution (520) temperature is selected to provide a desired shoot to root temperature differential. It is contemplated that the plant growing system (500) is insulated and water-tight to the extent required as to maintain a desired temperature differential between the plant root (310) and plant shoot (315). An exemplary plant growing system includes irrigation pipe (535) conveying irrigation nutrient solution (520) through the soil (510) and about (525) the plant roots (310). Additionally, insulative or dissipative light reflecting or absorbing material (540) may be placed between the plant shoot and root to facilitate and maintain a desired temperature differential.

Still further, insulative or dissipative light reflecting or absorbing material (545) may be suspended over the plant shoot (315) to facilitate and maintain a desired temperature differential. Many and varied outdoor soil based plant growing system (500) and techniques may be adapted to select and maintain a plant root (310) temperature independently of the circulating air (530) temperature and/or plant shoot (315) temperature.

By independently selecting a gas mixture temperature and the plant nutrient solution temperature; and by providing a plant nutrient solution temperature to gas mixture temperature differential of approximately 0° F. or of at least approximately 10° F. during different phases of plant development, the growth of plants belonging to the family Solanaceae may be improved.

As previously discussed, physiological ontogenic and morphogenic changes caused by shoot to root temperature differentials during plant growth may be exploited to modify a plant's development, and thus improve desired plant organs for industrial, scientific, and medical purposes. However, the developmental changes resulting from differential shoot to root temperatures in part are dependent upon the plant family, genera, and/or species being improved. One plant with a cold shoot and hot roots will react differently from a plant of another plant family, as will one plant variety from another of the same plant family.

In Growth Responses of Hemp to Differential Soil and Air Temperatures, by Clarence H. Nelson, Plant Physiol. 1944 April; 19(2): 294-309., (hereinafter “Nelson”, and hereby incorporated by reference in its entirety) Nelson explains that specific development changes occur in C. sativa L. plants grown in such temperature differential environments. Nelson placed C. sativa L. into four unchanged temperature conditions (series), remaining unchanged throughout the vegetative growth phase of the plants. The four temperature conditions Nelson used where:

Shoot at 86° F., and roots at 86° F., (hereinafter “H/H”).

Shoot at 86° F., and roots at 60° F., (hereinafter “H/L”).

Shoot at 60° F., and roots at 86° F., (hereinafter “L/H”).

Shoot at 60° F., and roots at 60° F., (hereinafter “L/L”).

The following was observed and concluded by Nelson:

All four temperature series plants developed uniformly for the first four weeks of growth, with significant developmental changes being observed after seven weeks of growth.

The H/H Plants:

Vegetative growth was the most robust, with the smallest internodal length and stem diameter until maturity, and with the greatest root development. Specifically, H/H series plants exhibited the maximum stem elongation; greatest number of nodes produced; earliest blossom and seed formation; least aggregate leaf area; greatest number of leaf abscissions; and the highest absolute water consumption during growth.

The H/L Plants:

Both the aggregate number of leaves produced and the total leaf area per plant where smaller than in any other series. The leaves themselves were relatively thin and more finely veined. This series showed the least anabolic efficiency as noted by their low fresh and dry weight per plant. There was a possibility of impaired translocation of reserves into the region below the ground line due to low root temperatures.

The L/H Plants:

Had the maximum stem diameter and greatest internodal length. Leaves were very coarse in texture, large in size, and extremely thick. Leaf abscission was lowest of the four series, and leaf and stem production was favored. Plants of this series had the largest stem diameter, largest individual leaves, and highest aggregate dry weight.

The L/L Plants:

The leaves on these plants were relatively large, attaining the maximum area per leaf of the four series. Though the stems attained a height only slightly greater than in the L/H plants, the stem diameter was relatively large. The vegetative habit was essentially similar to L/H plants except as to stem length.

It has surprisingly been found during instant inventor experimentation that applying similar shoot to root temperature differentials to Solanaceae plants also improves the quality of various plant organs and overall plant growth. While not wishing to be bound by any one theory or combination of theories, it is believed that, the timing, sequence, and range of shoot-to-root temperature differentials selected during development of Solanaceae plants, during selected phases of plant growth, improves the growth of various organs and characteristics of Solanaceae plants and improves such plants for industrial, scientific, and medical uses.

It was observed during instant inventor experimentation that Solanaceae plants placed in a shoot to root temperature differential condition exhibit physiological ontogenic changes if the temperature differential is approximately 10° F. or greater. Below this approximate 10° F. temperature differential threshold, Solanaceae plants exhibit no or little significant physiological ontogenic change, even after long term temperature differential exposure. Hereinafter, this approximate 10° F. or greater temperature differential will be symbolized either as a “>10° F.+/−” or as a “>10° F.−/+” temperature condition when the plant being improved belongs to the Solanaceae family; the first position representing selected shoot temperature, and the second position representing selected root temperature, and the “+” and “−” indicative of whether the shoot or root temperature is above or below the other.

Hereinafter, an approximate 0° F. shoot to root temperature differential will be symbolized as a “0° F. S/R” temperature condition.

Some Solanaceae plant varieties are relatively small in size and lend themselves to modern hydroponic, aeroponic, and/or aquaponic growing methods. Therefore, providing effective shoot to root temperature differentials for a Solanaceae variety is extremely easy using a plant growing system similar to as described in FIG. 1, FIG. 2, and FIG. 3.

In an embodiment of the present invention, providing selected shoot to root temperature differentials during Solanaceae seedling, vegetative, and flora growth phases, at least one organ of the plant may be improved for industrial, scientific, or medical use.

Nelson's observations and instant inventor experimental data indicate that plants exposed to all four differential temperature condition types exhibited little or no developmental differences during the first 4 weeks of growth, and providing an 0° F. S/R temperature condition during seedling growth phase results in improved growth and development of the plant for all intended uses.

In an embodiment of the present invention, the primary organ for desired improvement are Solanaceae plant stems and/or leaves.

Desired plant characteristics for stem improvement are: robust vegetative growth, stem elongation, a wide stem diameter, the least number of nodes, long internode length, and maximum plant material weight and density.

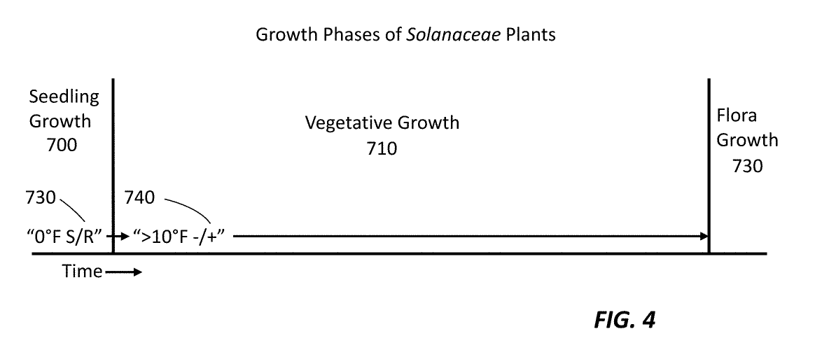

As depicted in FIG. 4, after providing a seedling a 0° F. S/R temperature condition (730), and providing during vegetative growth a >10° F.−/+temperature condition (740), improved plant stem and/or leaf growth, weight, and density can be observed.

Typically, for stem and/or leaf production, the plant is harvested before, or never induced into, the plant flora growth (730) phase.

In another embodiment of the present invention, the target for desired improvement is Solanaceae plant reproductive organs.

Desired plant characteristics for reproductive organ improvement are: robust vegetative growth, moderate stem diameter, the greatest number of nodes, short internode length, and improved reproductive organ number, density, size, and weight.

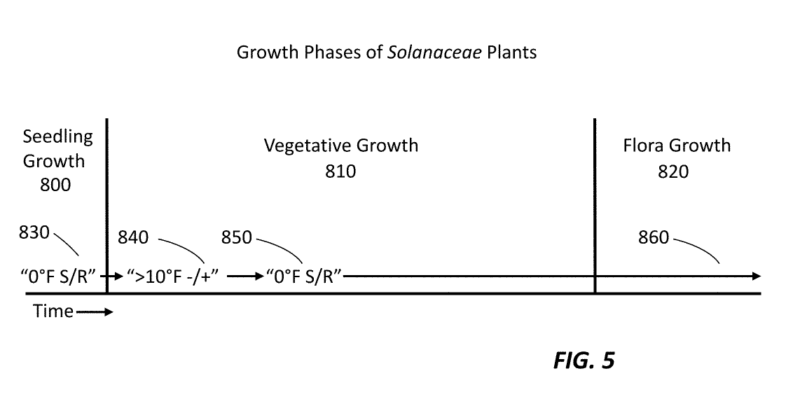

Referring to FIG. 5, after providing a seedling a 0° F. S/R temperature condition (830), and then providing during a first portion of vegetative growth an >10° F.−/+temperature condition (840) results in a thickening of the stem wall and an increase in stem diameter. Vigorous root growth also continues under >10° F.−/+temperature conditions.

This shoot to root temperature differential sequence slightly-to-moderately thickens stems and branches during an early portion of vegetative growth, then returning the plant to a 0° F. S/R temperature condition (850) results in continued robust vegetative growth, a moderate stem diameter, a large number of nodes, and short internodal length; all desirable characteristics in preparation for entering the plant flora growth (820) phase.

Plant growth is finished while maintaining a 0° F. S/R temperature condition (860) during the plant flora growth (820) phase, which improves reproductive organ, density, size, and weight.

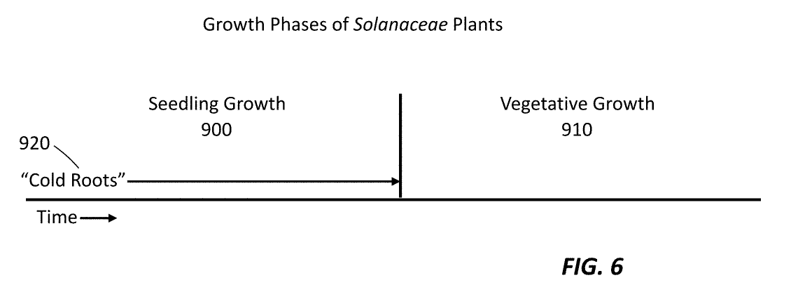

As depicted in FIG. 6, in another embodiment of the present inventive method, a Solanaceae variety root temperature is reduced wherein the plant nutrient solution temperature is harmful to plant pathogens wherein the pathogens become intolerant of the temperature. Plants in the seedling growth phase may be placed in this “cold roots” temperature condition (920) in order to prevent or eradicate infection by a pathogen or pest, while maintaining both vigorous shoot and root growth. It should be noted that during the seedling growth phase, little if any significant developmental changes were observed by Nelson nor the instant inventor; therefore the primary objective in reducing root temperature during seedling growth is the prevention or treatment of a harmful plant pathogen or pest.

To prevent plant root hypoxia which in turn prevents pathogen or pest infection and infestation, and to increase nutrient uptake by a plant; intelligently so, the vast majority of cultivators reduce water and/or nutrient solution and grow medium temperatures to between 55-70 degrees F. regardless of the air/gas mixture provided and maintained. This indeed will increase solubility making supplementary oxygen bubblers, injectors, and the like much more effective and efficient. However, as observed by Nelson, this common nutrient temperature reduction while maintaining the plant shoot at higher temperatures results in a H/L shoot to root temperature differential condition, which stunts and retards growth and development of plants; from seedlings to harvest.

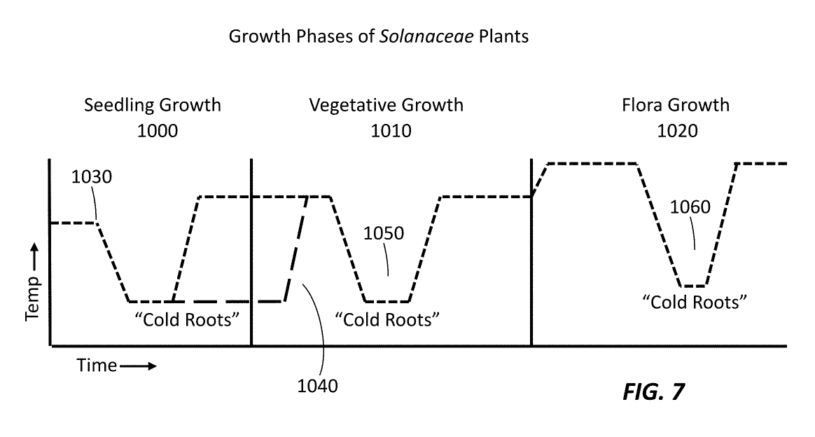

As depicted in FIG. 7, in another embodiment of the present inventive method, as observed by the instant inventor, temporarily reducing plant nutrient solution temperature (1030) for the purpose of eradicating or preventing infection by a harmful pathogen or pest has no or little physiological ontogenic or morphogenic affect if the period of “cold roots” is approximately less than 5 days in duration. This therapeutic period of “cold roots” may be accomplished during either plant seedling growth (1000) vegetative growth (1010) or flora growth (1020) phases. As depicted by temperature line 1040, preferably if a plant is placed in a therapeutic “cold roots” condition during seedling growth, in order to prevent pathogen or pest re-infection, the plant may remain in that “cold roots” condition until morphogenic changes for a particular growing sequence requires an increase in plant root temperature. As observed during instant inventor experimentation, several periods of therapeutic “cold roots” of 3-5 days duration (1050,1060) were executed randomly throughout both plant vegetative and flora growth phases without noticeable morphogenic difference, as compared to plants which were not placed in a therapeutic “cold root” condition.

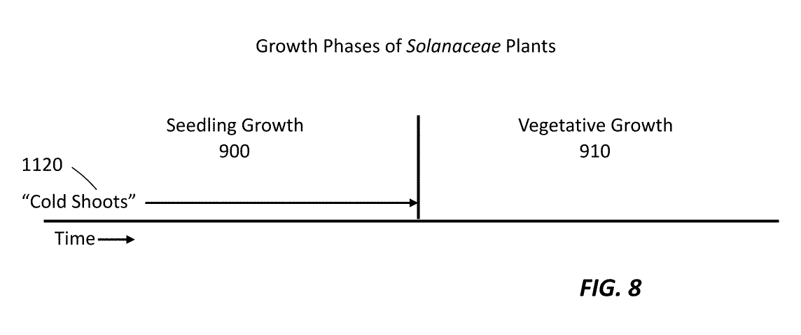

As depicted in FIG. 8, in another embodiment of the present inventive method, a Solanaceae variety shoot temperature is reduced wherein the plant air or gas mixture temperature is harmful to plant pathogens or pests wherein the pathogens or pests become intolerant of the reduced temperature. Plants in the seedling growth phase may be placed in this “cold shoots” temperature condition (1120) in order to prevent or eradicate infection or infestation by a pathogen or pest, while maintaining both vigorous shoot and root growth. It should be noted that during the seedling growth phase, little if any significant developmental changes were observed by Nelson nor the instant inventor; therefore the primary objective in reducing shoot temperature during seedling growth is the prevention or treatment of a harmful plant pathogen or pest.

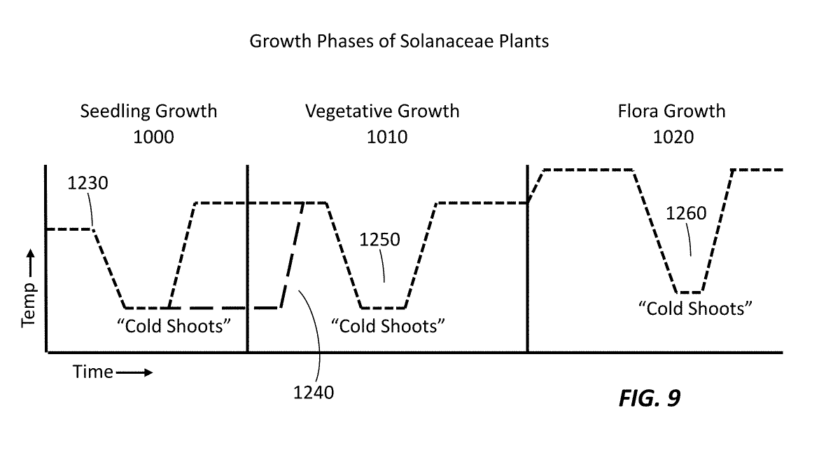

As depicted in FIG. 9, in another embodiment of the present inventive method, as observed by the instant inventor, temporarily reducing plant gas mixture temperature (1230) for the purpose of eradicating or preventing infection by a harmful pathogen or pest has no or little physiological ontogenic or morphogenic affect if the period of “cold shoots” is approximately less than 5 days in duration. This therapeutic period of “cold shoots” may be accomplished during either plant seedling growth (1000) vegetative growth (1010) or flora growth (1020) phases. As depicted by temperature line 1240, preferably if a plant is placed in a therapeutic “cold shoots” condition during seedling growth, in order to prevent pathogen or pest re-infection, the plant may remain in that “cold shoots” condition until morphogenic changes for a particular growing sequence requires an increase in plant gas mixture temperature. As observed during instant inventor experimentation, several periods of therapeutic “cold shoots” of 3-5 days duration (1250,1260) were executed randomly throughout both plant vegetative and flora growth phases without noticeable morphogenic difference, as compared to plants which were not placed in a therapeutic “cold shoot” condition.

When changes are made in plant environmental temperature, preferably the change should be made gradually rather than abruptly; as to avoid overly stressing the plant. Such stress causes growth retardation and stunts the plant overall. Preferably, selected gas mixture temperature and/or plant nutrient solution temperature changes should be less than approximately 20° F. in any one twenty-four hour period.

It was observed during instant inventor experimentation that Solanaceae plant developmental changes caused by shoot to root temperature differentials tended to increase in rate of change and in degree or extent of change as shoot to root temperature differentials were increased.

Utilizing carbon-dioxide augmentation during plant development allows for increased gas mixture temperatures, and therefore increased shoot to root temperature differentials. The increased shoot to root temperature differentials allowed utilizing carbon-dioxide augmentation results in improved plant morphogenic changes, improved plant growth overall, and thus reduces cultivation cost and time while increasing crop yields.

It should be understood that all Figures only illustrative of various aspects of the present inventive method, and are not intended to be accurate or to scale as to time, temperature, or physical dimensions related to the described inventive shoot to root temperature sequence.

Although the inventive method has been described with reference to a particular sequence of shoot to root temperature differentials and/or temperature values, and the like, these are not intended to exhaust all possible sequences or temperatures, and indeed many other modifications and variations will be ascertainable to those of skill in the art.

Having thus described several embodiments for practicing the inventive method, its advantages and objectives can be understood. Variations from the drawings and description can be made by one skilled in the art without departing from the scope of the invention, which is to be determined from the following claims.

Although the inventive method has been described with reference to a particular plant family, other plant families and genera may also be improved by practicing the inventive method, without departing from the objectives and scope of the instant invention. It is contemplated this group includes modern green algae, seedless non-vascular, seedless vascular, gymnosperm, and angiosperm plant families.

Accordingly, this invention is not to be limited by the embodiments as shown in the drawings and/or as described in the description, since these are given by way of example only and not by way of limitation.

What is claimed is:

1. A method of improving the growth of plants belonging to the family Solanaceae comprising:
providing a plant growing system configured for growing a Solanaceae plant having roots and a shoot, the plant growing system including a plant nutrient solution about the plant roots and a gas mixture circulating about the plant shoot;
selecting the gas mixture temperature;
selecting the plant nutrient solution temperature independently of the gas mixture temperature; and
providing a plant nutrient solution to gas mixture temperature differential of at least approximately 10° F. during different phases of plant development.

2. The method of claim 1 wherein the phases of plant development comprise seedling growth, vegetative growth, and flora growth.

3. The method of claim 1 wherein the method improves plant stem and/or leaf development.

4. The method of claim 1 wherein the method improves plant root development.

5. The method of claim 1 wherein the method improves plant reproductive organ development.

6. The method of claim 1 wherein the growth of the plant is improved based at least in part on the plant variety, at least in part on the plant nutrient solution N-P-K concentration level, and at least in part on the plant growth phase.

7. The method of claim 1 wherein the gas mixture comprises air, and the method further comprises the step of increasing the carbon-dioxide level of the air based at least in part upon the selected plant nutrient temperature and at least in part on the selected air temperature.

8. The method of claim 1 wherein any change to the selected gas mixture temperature or the selected plant nutrient solution temperature is made in less than approximately 20° F. increments during any one twenty-four hour period.

9. A method of preventing or treating infection or infestation by a pathogen or pest of plants belonging to the family Solanaceae comprising:
providing a plant growing system configured for growing a Solanaceae plant having roots and a shoot, the plant growing system including a plant nutrient solution about the plant roots and a gas mixture circulating about the plant shoot; and
selecting either a gas mixture temperature or a nutrient solution temperature independently of the other;
wherein the selected temperature is lethal to a pathogen and/or pest belonging to the group consisting of insects, fungi, molds, mildews, bacterium, and combinations thereof at the selected gas mixture temperature or nutrient solution temperature.

10. The method of claim 9; wherein the selected gas mixture temperature is at least 10° F. above the nutrient solution temperature, and is a temperature which does not cause the plant of a selected variety to be irremediably harmed.

11. The method of claim 9; wherein the selected nutrient solution temperature is at least 10° F. above the gas mixture temperature, and is a temperature which does not cause the plant of a selected variety to be irremediably harmed.

12. A plant growing system configured to grow a Solanaceae plant having roots and a shoot, the plant growing system comprising:
a plant nutrient solution located about the roots of the plant; and
a gas mixture circulating about the shoot of the plant,
wherein the gas mixture has a temperature that is selected independently of or based at least in part on a temperature of the plant nutrient solution, and
wherein during different phases of plant development, a plant nutrient solution to gas mixture temperature differential is provided such that the temperature differential is greater than approximately 10° F. during at least part of one of the different phases of plant development.

13. The plant growing system of claim 12, wherein the plant growing system is insulated, air-tight, and water-tight to the extent required as to maintain the temperature differential between the plant root and the plant shoot.

14. The plant growing system of claim 12, further comprising material placed between the plant shoot and the plant root to maintain the temperature differential between the plant root and the plant shoot.

15. The plant growing system of claim 12, further comprising material suspended over or about the plant shoot to provide a temperature differential between the plant root and the plant shoot.

16. The plant growing system of claim 12, further comprising an irrigation system to deliver the plant nutrient solution to the roots of the plant.

17. The plant growing system of claim 12, wherein the system is self-contained except for electrical input, water input, water output, and ventilation.

18. The plant growing system of claim 12, wherein the system is self-contained except for solar input, water input, water output, and ventilation.

19. The plant growing system of claim 12, wherein the system is portable.

20. The plant growing system of claim 12, wherein the system is configured to grow a plant in zero gravity.
